(19) United States
(12) Patent Application Publication
(10) Pub. No.: US 2013/0334904 A1
(43) Pub. Date: Dec. 19, 2013

(54) ELECTROMOTIVE FORCE GENERATOR AND ELECTRIC POWER GENERATING MODULE USING THE SAME

(71) Applicant: ARBL CO., LTD., Taichung City (TW)

(72) Inventors: Chung-Pin LIAO, Taichung City (TW); Jyun-Lin HUANG, New Taipei City (TW); Zi-Peng ZHAO, Bade City (TW)

(73) Assignee: ARBL CO., LTD., Taichung City (TW)

(21) Appl. No.: 13/756,325

(22) Filed: Jan. 31, 2013

(30) Foreign Application Priority Data
Jun. 13, 2012 (TW) 101121156

(51) Int. Cl. H02K 1/17

(52) U.S. Cl. CPC H02K 1/17
USPC 310/36

(57) ABSTRACT

An electric power generating module includes an electromotive force (EMF) generator and a circuit unit. The EMF generator has a shell having two opposite plates, a coil unit mounted to one of the plates, first and second stationary magnets disposed in the shell with different magnetic pole, and a moveable magnet having a magnetic pole opposite to that of the first stationary magnet. The moveable magnet is moveable between a first position adjacent to a first side of the second stationary magnet and a second position adjacent to a second side of the second stationary magnet along a circumference of the first stationary magnet across a space defined between the coil unit and the other one of the plates. The circuit unit is electrically connected with the coil unit. When the EMF generator is shaken, electric power is produced by the electric power generating module.

### BACKGROUND OF THE INVENTION

1. Field of the Invention

The present invention relates generally to electric power generating modules and more particularly, to an electromotive force (hereinafter referred to as ‘EMF’) generator having coils producing induced electromotive force by changing magnetic flux passing therethrough, and an electric power generating module using the EMF generator.

2. Description of the Related Art

Remote controls for television, air-conditioner, door plate of building, locking system of automobile, portable game machine and so on are extensively used by people in daily life. These remote controls are generally powered by battery. It usually happens that the battery is running out of power suddenly but new battery is not available for replacement, resulting in inconvenience to the user.

These remote controls are generally portable devices, which are usually moved and placed by user place to place, and some of which will be often carried by user and then shaken along with the user's body motion. In addition, some of these remote controls, such as remote joysticks of game machines, will be intensively or purposely shaken by the user when they are in use. In other words, user will unintentionally apply kinetic energy to the remote control. If the kinetic energy exerted on the remote control can be converted inside the remote control into electric power for being used by the remote control, money and energy can be saved and the situation of running out of battery can be avoided. On the other hand, most of the remote controls are used in a very short term each time, which may consume little electric power. The electric power converted from the kinetic energy produced by the user's shaking the remote control with a few seconds before the remote control is used may be enough to fulfill the requirement of the electric power that the remote control is needed for one-time use. That is, if the kinetic energy exerted on the remote control by the user can be effectively converted into electric power, the remote control may not need to be equipped with battery.

### SUMMARY OF THE INVENTION

The present invention has been accomplished in view of the above-noted circumstances. It is therefore a primary objective of the present invention to provide an EMF generator and an electric power generating module using the EMF generator which can produce induced electromotive force when it is moved or shaken so as to make the electric power generating module produce electric power, thereby saving money and energy and enhancing the convenience of use of the portable device needing electric power for operation.

To achieve the above-mentioned objective, an electromotive force (EMF) generator provided by the present invention comprises a shell, at least one coil unit, a first stationary magnet, a second stationary magnet and a moveable magnet. The shell has two plates oppositely and spacedly arranged with each other, and a receiving space between the two plates. The coil unit is mounted to one of the plates of the shell. The first and second stationary magnets are fixedly disposed in the receiving space and have different magnetic pole. The second stationary magnet includes a first side and a second side opposite to the first side. The moveable magnet is provided with a magnetic pole opposite to that of the first stationary magnet and located in the receiving space. The moveable magnet is moveable between a first position adjacent to the first side of the second stationary magnet and a second position adjacent to the second side of the second stationary magnet along a circumference of the first stationary magnet across a space defined between the coil unit and the other one of the plates.

The electric power generating module provided by the present invention comprises the above-mentioned EMF generator and a circuit unit electrically connected with the coil unit of the EMF generator. The circuit unit includes an energy storing component.

As a result, when the EMF generator is moved or shaken, the moveable magnet will move along the circumference of the first stationary magnet and pass across the coil unit in such a way that the moveable magnet reciprocally moves between the first and second positions by means of the characteristic that the moveable magnet has a different magnetic pole from that of the second stationary magnet to result in a magnetically repellent force therebetween. Therefore, the magnetic flux passing through the coil unit changes all the time to produce induced electromotive force, making the coil unit generate electric current to be stored in the energy storing component. The electric power generating module can be built in a portable device, such as a remote control that enables the electric power generating module to produce electric power conveniently, such that the electric power produced by the electric power generating module can be used by the portable device, thereby saving money and energy and preventing the portable device from running out of power suddenly so as to enhance the convenience of use of the portable device.

### BRIEF DESCRIPTION OF THE DRAWINGS

The present invention will become more fully understood from the detailed description given herein below and the accompanying drawings which are given by way of illustration only, and thus are not limitative of the present invention, and wherein:

FIG. 1 is a schematic top view of an electromotive force generator according to a first preferred embodiment of the present invention, showing that a moveable magnet of the EMF generator is located at a middle position;

FIG. 2 is a schematic cross-sectional view of an electric power generating module using the EMF generator;

FIG. 3 is a schematic cross-sectional view of the EMF generator, showing the moveable magnet is located at a first position;

FIG. 4 is similar to FIG. 3, but showing that the moveable magnet is located at a second position; and

FIG. 5 is a schematic top view of an electromotive force generator according to a second preferred embodiment of the present invention.

### DETAILED DESCRIPTION OF THE INVENTION

It is to be mentioned that same or similar parts disclosed in the preferred embodiments and the drawings, which will be detailedly described hereunder, are denoted with same reference numerals for the purpose of concise illustration of the present invention.

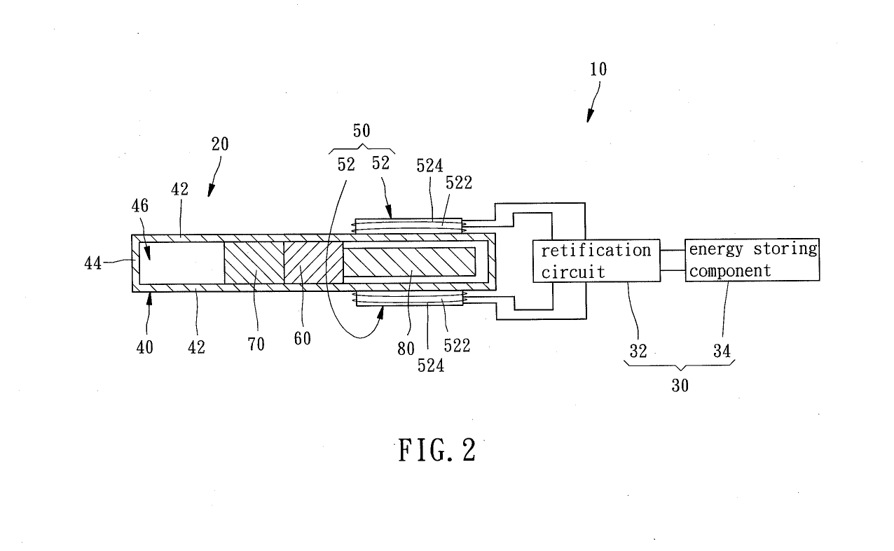

As shown in FIG. 2, an electric power generating module, configured according to a first preferred embodiment of the present invention and denoted with reference numeral 10 in the drawing, comprises an electromotive force (EMF) generator 20 and a circuit unit 30.

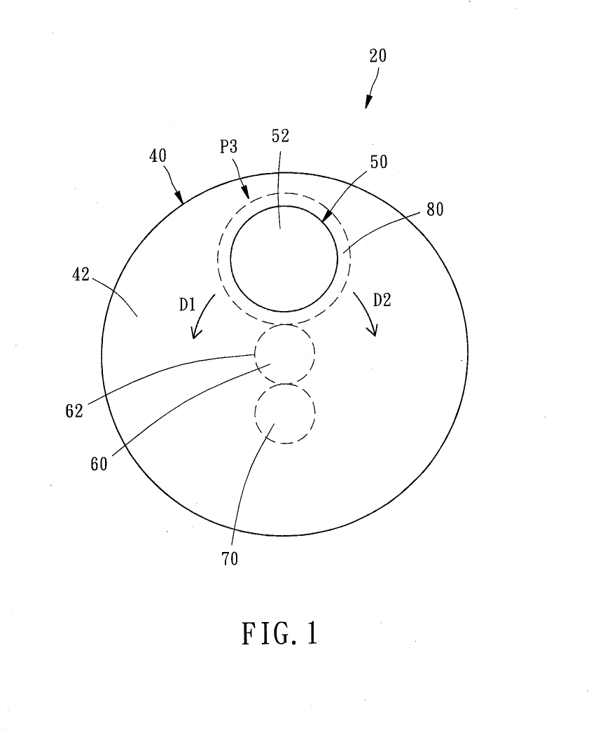

Referring to FIGS. 1-4, the EMF generator 20 includes a shell 40, a coil unit pair 50, a first stationary magnet 60, a second stationary magnet 70 and a moveable magnet 80.

The shell 40 is made of a non-ferroelectric material, including but not limited to aluminum, fiber reinforced plastic and acrylic resin. The shell 40 is configured having two circular plates 42 oppositely and spacedly arranged with each other, an annular periphery plate 44 connected between the two circular plates 42, and a receiving space 46 defined by the circular plates 42 and the annular periphery plate 44.

The coil unit pair 50 is composed of two coil units 52. As same as the conventional coil unit, each coil unit 52 is composed of a magnetically conductive core 522 and a wire coil 524 wound around the core 522. The coil units 52 are respectively attached on the two plates 42 by adhesive, such as epoxy resin or synthetic resin, and aligned in a line with each other.

The magnets 60, 70 and 80 are circular permanent magnets. The magnetic pole of the moveable magnet 80 is different from that of the stationary magnet 60 and same as that of the stationary magnet 70. Specifically speaking, if the magnetic pole of the magnet 60 is ‘N pole’, the magnetic poles of the magnets 70 and 80 will be ‘S pole’ and vice versa. These magnets 60, 70 and 80 are disposed in the receiving space 46.

The magnets 60 and 70 are abutted with each other and fixedly mounted to the plates 42, such that the magnets 60 and 70 are stationary relative to the shell 40. The moveable magnet 80 is magnetically attracted on a circumference 62 of the first stationary magnet 60.

The circuit unit 30 is composed of a rectification circuit 32 and an energy storing component 34, which may be realized as a capacity or a rechargeable battery. Two terminals of each wire coil 524 are electrically connected with the circuit unit 30.

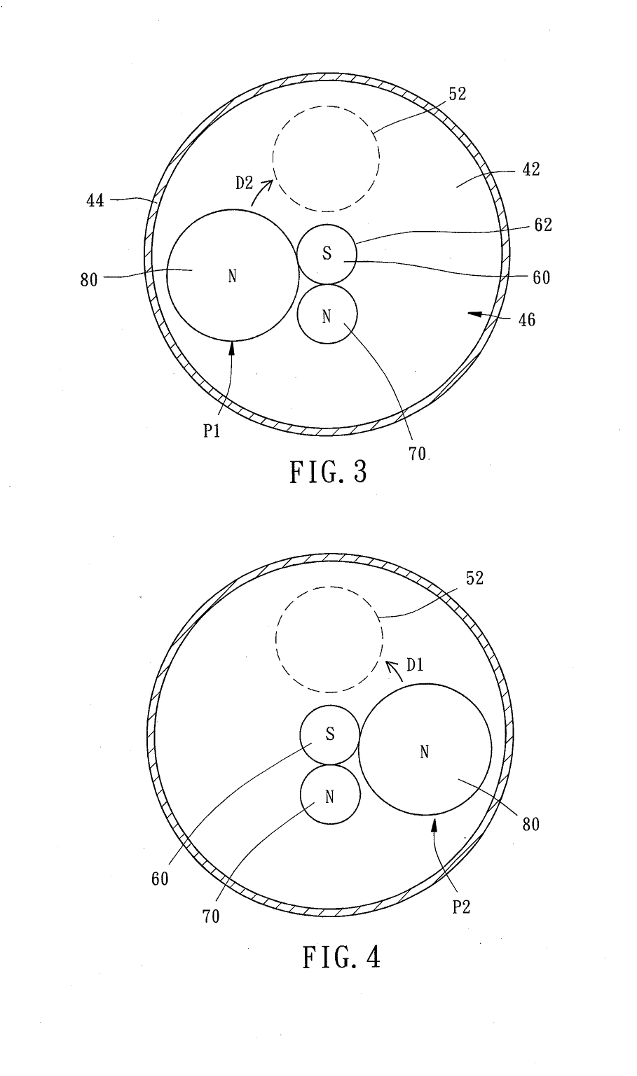

When the EMF generator 20 is moved or shaken, the moveable magnet 80 can move along the circumference 62 of the first stationary magnet 60 toward a first direction D1 or a second direction D2 as shown in FIG. 1. When the moveable magnet 80 moves toward the first direction D1 to a first position P1 that is adjacent to a side of the second stationary magnet 70, namely a first side of the second stationary magnet 70, as shown in FIG. 3, the magnetically repellent force between the magnets 70 and 80 will force the moveable magnet 80 to reversely move toward the second direction D2. When the moveable magnet 80 moves toward the second direction D2 to a second position P2 that is adjacent to another side of the second stationary magnet 70, namely a second side opposite to the first side of the second stationary magnet 70, as shown in FIG. 4, the magnetically repellent force between the magnets 70 and 80 will force the moveable magnet 80 to reversely move toward the first direction D1. When the moveable magnet 80 moves to a middle position P3 as shown in FIG. 1, the first stationary magnet 60 is located between the second stationary magnet 70 and the moveable magnet 80, and the moveable magnet 80 is located between the two coil units 52.

In other words, by means of moving or shaking the EMF generator 20 and the magnetically repellent force generated between the magnets 70 and 80, the moveable magnet 80 can reciprocally move between the first position P1 and the second position P2 across the space between the two coil units 52. By this way, an induced electromotive force will be produced due to the continuous change of magnetic flux passing through the coil units 52, resulting in that the coil units 52 produce electric current and the electricity energy will be stored in the energy storing component 34.

The electric power generating module 10 can be simply applied as a power generator. Alternatively, the electric power generating module 10 can be built in a portable device, such as a remote control, which will be generally carried by the user and/or moved or shaken by the user when it is operated, such that the EMF generator 20 will be often moved or shaken to make the electric power generating module 10 produce electric power that can be used by the portable device so as to prevent the portable device from running out of power. By means of the built-in electric power generating module 10, the electric power can be provided in a cost-saving manner and the convenience of use of the portable device can be enhanced.

In the first preferred embodiment, the thickness of the moveable magnet 80 is smaller than that of the first stationary magnet 60, as shown in FIG. 2, such that the moveable magnet 80 can be kept at a distance from the shell 20 without touching the shell 20. By this design, the moveable magnet 80 can move with less friction and will not bump the second stationary magnet 70 because the moveable magnet 80 and the second stationary magnet 70 are magnetically repelled from each other. Therefore, the moveable magnet 80 can move with a fast speed and a low noise.

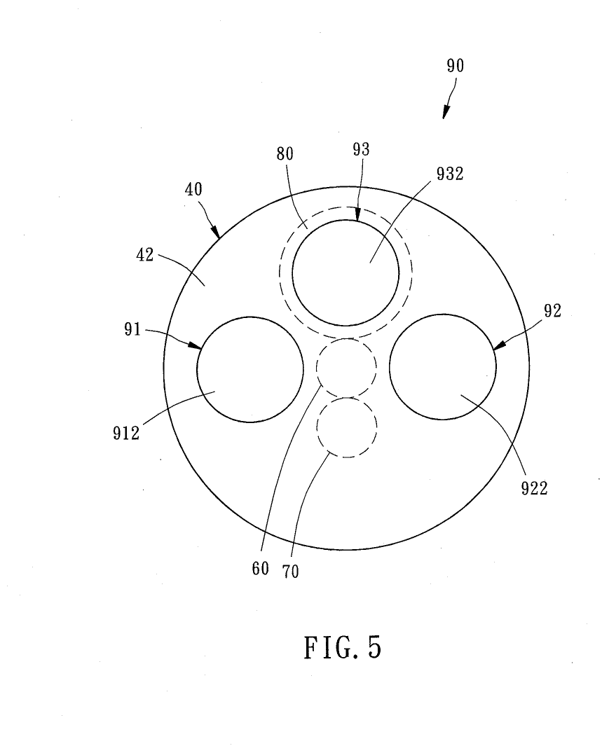

FIG. 5 shows an EMF generator 90 according to a second preferred embodiment of the present invention. The difference between the EMF generator 90 in this embodiment and the EMF generator 20 of the first embodiment lies in that more coil units are provided in this EMF generator 90. Specifically speaking, first, second and third coil unit pairs 91, 92 and 93 are mounted on the shell 40 of the EMF generator 90. The first coil unit pair 91 is composed of two first coil units 912 respectively mounted on the two circular plates 42 of the shell 40 and corresponding in location to the position P1 of the moveable magnet 80 as defined in the first embodiment and FIG. 3. The second coil unit pair 92 is composed of two second coil units 922 respectively mounted on the two circular plates 42 of the shell 40 and corresponding in location to the position P2 of the moveable magnet 80 as defined in the first embodiment and FIG. 4. The third coil unit pair 93 is composed of two third coil units 932 respectively mounted on the two circular plates 42 of the shell 40 and corresponding in location to the position P3 of the moveable magnet 80 as defined in the first embodiment and FIG. 4. In this way, when the moveable magnet 80 is forced to move, the moveable magnet 80 can pass across the coil units 912, 922 and 932 to enable the coil units 912, 922 and 932 to provide the induced electromotive force so as to provide more electric power.

It'll be appreciated that the amount of the coil unit is not specially limited and the coil units are not limited to be face-to-face paired. In addition, the location of the coil unit is not limited to the first position P1, the second position P2 or the middle position P3 as long as the moveable magnet 80 can travel across the space between one of the circular plates 42 and each coil unit. That is, any design that allows each of the coil units to be arranged at a location corresponding to the traveling path of the moveable magnet 80 can be adopted in the present invention.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. An electromotive force generator comprising:
a shell having two plates oppositely and spacedly arranged with each other, and a receiving space between the two plates;
at least one coil unit mounted to one of the plates of the shell;
a first stationary magnet fixedly disposed in the receiving space;
a second stationary magnet fixedly disposed in the receiving space and provided with a first side, a second side opposite to the first side, and a magnetic pole opposite to that of the first stationary magnet; and
a moveable magnet provided with a magnetic pole opposite to that of the first stationary magnet and located in the receiving space, the moveable magnet being moveable between a first position adjacent to the first side of the second stationary magnet and a second position adjacent to the second side of the second stationary magnet along a circumference of the first stationary magnet across a space defined between the at least one coil unit and the other one of the plates.

2. The electromotive force generator of claim 1, wherein the moveable magnet has a thickness smaller than that of the first stationary magnet.

3. The electromotive force generator of claim 1, comprising at least one coil unit pair having two said coil units respectively mounted to the plates of the shell; the moveable magnet is moveable across a space between two said coil units.

4. The electromotive force generator of claim 3, comprising a plurality of said coil unit pairs.

5. The electromotive force generator of claim 1, wherein when the moveable magnet is located at a middle position between the first and second positions, the first stationary magnet is located between the second stationary magnet and the moveable magnet and the moveable magnet is located between the coil unit and the other one of the plates.

6. The electromotive force generator of claim 5, comprising a coil unit pair including two said coil units respectively mounted to the plates of the shell; when the moveable magnet is located at the middle position, the moveable magnet is located between two said coil units.

7. The electromotive force generator of claim 1, comprising a plurality of coil units.

8. The electromotive force generator of claim 7, wherein the coil units comprise at least one first coil unit, at least one second coil unit and at least one third coil unit; when the moveable magnet is located at the first position, the moveable magnet is located between the first coil unit and the other one of the plates; when the moveable magnet is located at the second position, the moveable magnet is located between the second coil unit and the other one of the plates; when the moveable magnet is located at a middle position between the first and second positions, the first stationary magnet is located between the second stationary magnet and the moveable magnet and the moveable magnet is located between the third coil unit and the other one of the plates.

9. The electromotive force generator of claim 8, comprising a first coil unit pair including two said first coil units respectively mounted to the plates of the shell, a second coil unit pair including two said second coil units respectively mounted to the plates of the shell, and a third coil unit pair including two said third coil units respectively mounted to the plates of the shell; when the moveable magnet is located at the first position, the moveable magnet is located between two said first coil units; when the moveable magnet is located at the second position, the moveable magnet is located between two said second soil units; when the moveable magnet is located at the middle position, the moveable magnet is located between two said third coil units.

10. An electric power generating module comprising:
an electromotive force generator as claimed in claim 1; and
a circuit unit electrically connected with the coil unit of the electromotive force generator and having an energy storing component.

11. The electric power generating module of claim 10, wherein the moveable magnet has a thickness smaller than that of the first stationary magnet.

12. The electric power generating module of claim 10, wherein the electromotive force generator comprises at least one coil unit pair having two said coil units respectively mounted to the plates of the shell; the moveable magnet is moveable across a space between two said coil units.

13. The electric power generating module of claim 12, wherein the electromotive force generator comprises a plurality of said coil unit pairs.

14. The electric power generating module of claim 10, wherein when the moveable magnet is located at a middle position between the first and second positions, the first stationary magnet is located between the second stationary magnet and the moveable magnet and the moveable magnet is located between the coil unit and the other one of the plates.

15. The electric power generating module of claim 14, wherein the electromotive force generator comprises a coil unit pair including two said coil units respectively mounted to the plates of the shell; when the moveable magnet is located at the middle position, the moveable magnet is located between two said coil units.

16. The electric power generating module of claim 10, wherein the electromotive force generator comprises a plurality of coil units.

17. The electric power generating module of claim 16, wherein the coil units comprise at least one first coil unit, at least one second coil unit and at least one third coil unit; when the moveable magnet is located at the first position, the moveable magnet is located between the first coil unit and the other one of the plates; when the moveable magnet is located at the second position, the moveable magnet is located between the second coil unit and the other one of the plates; when the moveable magnet is located at a middle position between the first and second positions, the first stationary magnet is located between the second stationary magnet and the moveable magnet and the moveable magnet is located between the third coil unit and the other one of the plates.

18. The electric power generating module of claim 17, wherein the electromotive force generator comprises a first coil unit pair including two said first coil units respectively mounted to the plates of the shell, a second coil unit pair including two said second coil units respectively mounted to the plates of the shell, and a third coil unit pair including two said third coil units respectively mounted to the plates of the shell; when the moveable magnet is located at the first position, the moveable magnet is located between two said first coil units; when the moveable magnet is located at the second position, the moveable magnet is located between two said second soil units; when the moveable magnet is located at the middle position, the moveable magnet is located between two said third coil units.
